(19) United States
(12) Patent Application Publication
(10) Pub. No.: US 2002/0148712 A1
(43) Pub. Date: Oct. 17, 2002

(54) Key-switch device corresponding to miniaturized notebook-size personal computer with reduced-thickness

(75) Inventors: Tsuyoshi Narusawa, Fukushima-ken (JP); Kazuhiro Yakoyama, Fukushima-ken (JP); Takayuki Ito, Fukushima-ken (JP); Sadayuki Yaginuma, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/122,023

(22) Filed: Apr. 11, 2002

(30) Foreign Application Priority Data
Apr. 12, 2001 (JP) 2001-114173
Jun. 14, 2001 (JP) 2001-180740

(51) Int. Cl. H01H 13/70

(52) U.S. Cl. 200/344

(57) ABSTRACT

A key-switch device includes a key-top having retainers formed on the back surface of the key-top, first and second levers disposed under the key-top, each lever including a base-end part and a pair of arms opposing each other and extending from both ends of the base-end part, the first and second levers being connected together rotatably about the substantial center of the pair of arms as an intersecting point, a lever-holding plate capable of retaining each lower end of the first and second levers, and an actuator member attached to and spanned between both the base-end parts of the first and second levers. Further, the actuator member has a concave slide-retainer-receiving part with the open top, and the base-end part of the second lever is slidably retained in the slide-retainer-receiving part.

### BACKGROUND OF THE INVENTION

1. Field of the Invention

The present invention relates to a key-switch device for use as various input devices of personal computers and word processors, etc., and in particular it relates to a key-switch device corresponding to miniaturization and reduction in thickness of notebook-size personal computers.

2. Description of the Related Art

Along with demands for reduction in size and miniaturizing of the entire device, various key-switch devices are proposed, in which a key-top is attached at the upper end of a pair of lever members crosswise linked together so as to change the angle between the pair of lever members link-crossing each other by moving up-and-down the key-top.

The type of conventional key-switch device will be described below with reference to FIGS. 26 to 29.

As shown in FIG. 26, the conventional key-switch device principally comprises a key-top 101, a holder member 130 disposed beneath the key-top 101, a guide-supporting member 106 for guiding and supporting the key-top 101 between an elevated position separated from the holder member 130 and a lowered position coming close to the holder member 130, and a rubber spring 131 arranged between the key-top 101 and the holder member 130.

The key-top 101, as shown in FIGS. 26 and 27, is provided with a character (not shown) formed on the top surface thereof by printing, and a pair of rotational retainers 101a and a pair of slide-retainers 101b, which are respectively arranged on the back surface. The pair of rotational retainers 101a are provided with retaining slots 104 respectively formed thereon while the pair of slide-retainers 101b are provided with retaining slots 105 respectively formed thereon.

The guide-supporting member 106 is formed of two resin-made lever members 107 and 108. As shown in FIG. 28, one U-shaped lever member 107 comprises a pair of arms 107a and a base-end part 107b connecting one end of one arm 107a to that of the other arm 107a. The other end of each arm 107a is provided with a retainer pin 107d protruded therefrom, and the central part of each arm 107a is provided with a shaft 107c formed inside thereof to protrude therefrom.

The other lever member 108, as shown in FIG. 29, comprises a pair of arms 108a, a base-end part 108b connecting one end of one arm 108a to that of the other arm 108a, retainer pins 108d formed at the other end of each arm 108a, and a depressing shaft 110 for connecting inside central parts of the arms 108a together. The central part of each arm 108a is provided with a hole 108c formed outside thereof, and at one end of each arm 108a, a retainer pin 108e is formed to protrude from outside.

The holder member 130, as shown in FIGS. 26 and 27, is formed of a metallic flat plate and comprises a pair of fitting parts 126 and a pair of retainers 127, which are cut-up from the surface. In addition, on the top surface of the holder member 130, a metallic frame 132 having plural openings 132a is arranged, and the fitting parts 126 and the retainers 127 protrude upwardly from the openings 132a of the frame 132.

The base-end part 107b of the one lever member 107 is rotatably retained in the retaining slots 104 of the rotational retainers 101a while the retainer pins 107d are slidably retained to the fitting parts 126 of the holder member 130.

Also, the retainer pins 108d of the other lever member 108 are slidably retained in the retaining slots 105 of the slide-retainers 101b of the key-top 101, while the retainer pins 108e are rotatably retained in the retainers 127 of the holder member 130.

Next, assembling of the key-switch device will be described: a conductive film sheet (not shown) is placed on the holder member 130. In addition, the sheet has the rubber spring 131 bonded thereon in advance. From the sheet, the fitting parts 126 of the holder member 130 and the retainers 127 protrude upwardly through the openings 132a of the frame 132.

Next, the one lever member 107 and the other lever member 108 are crosswise combined together so that each shaft 107c is rotatably inserted into the hole 108c so as to complete the guide-supporting member 106. Then, while the retainer pins 108e of the lever member 108 are press-fitted into holes of the retainers 127 of the holder member 130, the retainer pins 107d are slidably retained in the fitting parts 126. At this time, the depressing shaft 110 is positioned on the rubber spring 131.

Next, the key-top 101 is prepared so as to elastically abut the retainer pins 108d of the lever member 108 by depressing them from an obliquely upper direction (upper right part of FIG. 26), and the retainer pins 108d of the lever member 108 are inserted into the retaining slots 105 of the key-top 101 by trial and error.

Furthermore, the key-top 101 is urged to an upper part (the base-end part 107b and the retainer pins 108d) of the lever members 107 and 108 from the upper part so as to snap the retaining slots 104 of the key-top 101 into the base-end part 107b of the lever member 107.

In such a manner, the key-switch device is completed.

Next, operation of the key-switch device will be described: referring to FIG. 26, when pushing down the key-top 101, the base-end part 107b of the one lever member 107 rotates within the retaining slots 104 of the rotational retainers 101a while the retainer pins 108d of the other lever member 108 slides within the retaining slots 105 of the slide-retainers 101b horizontally (the lateral direction in FIG. 26). Simultaneously, the base-end part 108b of the lever member 108 rotates within retaining holes of the retainers 127 of the holder member 130 while the retainer pins 107d of the lever member 107 slides within the fitting parts 126 for slidably retaining the pin horizontally (the lateral direction in FIG. 26).

As a result, a bearing A for mutually journaling the lever members 107 and 108 on bearings moves downwardly while the depressing shaft 110 pushes the rubber spring 131 down gradually so as to be buckled. Thereby, a movable contact (not shown) within the rubber spring 131 establishes a short circuit in a fixed-contact pattern (not shown) on the holder member 130 so as to perform a predetermined switching operation.

When the pushing-down of the key-top 101 is canceled, the bearing A of both the lever members 107 and 108 is pushed up due to an elastic restoring force of the rubber spring 131 so as to perform the reverse operation (switching-off operation) to that mentioned above, resulting in returning the key-top 101 to the original position.

By the way, on the key-tops 101 attached to the lever members 107 and 108, there are various different characters or symbols printed thereon.

Then, after the key-switch device is assembled in advance, it may be required to change the key-top 101 to a different kind full of variety according to demand during assembling or after assembling. When removing the key-top 101 from the lever members 107 and 108, the key-top 101 has to be changed while maintaining the intersecting angle between the lever members 107 and 108 so as to have extremely complicated operation unless a specially designed jig is used.

Also, when assembling the key-switch device: first, after assembling the guide-supporting member 106, in which the lever members 107 and 108 are crossed with each other, both the retainer pins 108e and 108e of the lever member 108 are press-fitted into the retainers 127 of the holder member 130.

Then, the retainer pins 107d and 107d of the one lever member 107 are inserted into both the fitting parts 126 and 126 so as to assemble the lever members 107 and 108 into the holder member 130. However, since the slender resin lever member 107 is liable to deflect, the retainer pins 107d and 107d sliding on the surface of the holder member 130 may simply come off the fitting parts 126 during the assembling.

In addition, also when operating as the key-switch device, the retainer pins 107d of the lever member 107 are slidably retained in the fitting parts 126; however, since each retainer pin 107d simply extends in the longitudinal direction, it may come off the fitting part 126 when sliding.

The rotational retainers 101a of the key-top 101 are snapped into the base-end part 107b of the lever member 107 via the retaining slots 104; however, since the lower snapping side of the rotational retainer 101a is open, there is a problem that the key-top 101 may simply come off the lever member 107 when an external force pushing up the key-top 101 is applied.

When the key-top 101 is assembled into the lever members 107 and 108, the key-top 101 is assembled in a state that the retaining slots 104 and the retaining slots 105 formed on the back side of the key-top 101 are downward oriented so that they cannot be visually confirmed, resulting in the complicated assembling operation.

Also, when the base-end part 108b of the lever member 108 is inserted and assembled into the retainers 127 of the holder member 130, there is a problem that the base-end part 108b cannot be smoothly inserted by catching on the sliding contact part of the retainers 127 into the base-end part 108b of the lever member 108 on the top surface of the holder member 130.

### SUMMARY OF THE INVENTION

It is an object of the present invention to provide a key-switch device, in which assembling operation is further simplified when a key-top is attached to lever members crosswise intersecting each other.

In order to solve at least one of the problems described above, in accordance with a first aspect of the present invention, a key-switch device comprises a key-top having retainers formed on the back surface of the key-top, first and second levers disposed under the key-top, each lever including a base-end part and a pair of arms opposing each other and extending from both ends of the base-end part, the first and second levers being connected together rotatably about the substantial center of the pair of arms as an intersecting point, a lever-holding plate, which can retain each lower end of the first and second levers, and an actuator member attached to and spanned between both the base-end parts of the first and second levers, wherein the actuator member has a concave slide-retainer-receiving part with the open top, and wherein the base-end part of the second lever is slidably retained in the slide-retainer-receiving part.

Preferably, the base-end part of the first lever comprises a support-receiving part formed in the center of the base-end part for retaining one end of the actuator member, both ends of the support-receiving part being provided with retainer-receiving parts formed for retaining the retainers of the key-top, and wherein the retainers of the key-top and the retainer-receiving parts of the first lever are opposed in order to be retained together to have a section shaped like two-commas.

Preferably, the retainers of the key-top are classified into a pair of first retainers and a pair of second retainers, the pairs of first and second retainers being formed on the back surface of the key-top so as to protrude therefrom, wherein the back surface of the key-top is provided with a pair of first ribs formed to protrude from the back surface in the vicinity of the exterior of the second retainers, which oppose each other, and a second rib formed to extend in parallel with the first ribs in the vicinity of the first retainers other than any position between the first retainers, and wherein the key-top is inserted into and mounted on the first lever and the actuator member by respectively guiding the pair of arms of the first lever and the other end of the actuator member with the first ribs and the second rib.

Preferably, the base-end part of the first lever is rotatably journaled on bearings by one end of the actuator member, and the lower corner of the other end of the actuator member is obliquely cut.

In accordance with a second aspect of the present invention, a key-switch device comprises first and second levers rotatably connected to each other about an intersecting point, a key-top supported by the first and second levers so as to be movable up and down, a switch member being switchably operable in accordance with the up-and-down movement of the key-top, and a lever-holding plate having retainers for respectively retaining lower ends of the first and second levers, wherein the retainers of the lever-holding plate are classified into a lower-slide retainer for slidably retaining the lower end of the first lever and a retainer unit for rotatably journaling the lower end of the second lever on bearings, and wherein the lower end of the first lever is provided with a detachment-preventing part formed for preventing the lower end of the first lever from coming off the lower-slide retainer.

Preferably, the detachment-preventing part is an L-shaped retainer pin formed at the lower end of the first lever so as to protrude, and it is retained in the lower-slide retainer.

In accordance with a third aspect of the present invention, a key-switch device comprises first and second levers rotatably connected to each other about an intersecting point, a key-top supported by the first and second levers so as to be movable up and down, a switch member being switchably operable in accordance with the up-and-down movement of the key-top, and a lever-holding plate having retainers for respectively retaining lower ends of the first and second levers, wherein the respective first and second levers are provided with a base-end part and a pair of arms formed so as to extend from both ends of the base-end part and to oppose each other, the base-end part and the pair of arms being formed for guiding the up-and-down movement of the key-top, wherein the retainers of the lever-holding plate are classified into a lower-slide retainer for slidably retaining the lower end of the first lever and a retainer for rotatably journaling the lower end of the second lever on bearings, and wherein an end face of the first lever at the lower end, the end face sliding on the top surface of the lever-holding plate, is obliquely cut so as to have an acute angle relative to the extending direction of each arm.

In accordance with a fourth aspect of the present invention, a key-switch device comprises a key-top having a plurality of retainers formed on the back surface of the key-top, first and second levers disposed under the key-top, each lever including a base-end part and a pair of arms opposing each other and extending from both ends of the base-end part, the pairs of the arms being arranged movably with each other, a lever-holding plate, which can retain each of lower ends of the first and second levers, a connection member attached to and spanned between both of the base-end parts of the first and second levers, and a sheet switch arranged on the bottom surface of the lever-holding plate, wherein both ends of the connection member are provided with engaging parts formed for retaining to the retainers of the key-top, and the lever-holding plate is made of a metallic flat plate having substantially the same area as that of the key top.

In accordance with a fifth aspect of the present invention, a key-switch device comprises first and second levers connected to each other rotatably about an intersecting point, a key-top supported by the first and second levers so as to be movable up and down, a switch member being switchably operable in accordance with the up-and-down movement of the key-top, and a lever-holding plate for respectively retaining lower ends of the first and second levers, wherein the lever-holding plate is provided with a lower-slide retainer for slidably retaining the lower end of the first lever and a retainer unit for rotatably journaling the lower end of the second lever on bearings.

Preferably, part of the retaining part is open and the retaining part comprises a lower-rotational retainer for positioning the lower end of the second lever and a detachment-preventing retainer for preventing the lower end of the second lever from coming-off.

Preferably, the detachment-preventing retainer is a projection protruding from the lever-holding plate.

Preferably, the second lever comprises a pair of arms arranged in parallel with each other, a connection part for connecting one end of one arm to that of the other arm of the pair of arms, and a pair of lower-rotational-retaining projections formed to extend from each of the arms, in which the connection part is formed, and wherein the respective lower-rotational-retaining projections are retained in the lower-rotational retainer.

Preferably, the projection is provided with a fractured plane formed by projecting part of the lever-holding plate, and the connection part abuts the fractured plane.

Preferably, a plurality of the projections are formed along the connection part in the vicinity of the lower-rotational retainer, and the connection part is clamped with the lower-rotational retainer and the projections for preventing detachment.

Since the key-switch device according to the present invention is configured in the manner described in the first aspect of the present invention, the key-top can be simply mounted in a state that a predetermined intersecting angle between the first and second levers is maintained due to the actuator member.

Since the key-switch device is configured in the manner described in the second aspect of the present invention, even when the first lever, which slides laterally when pressing the key-top in the vertical direction, deflects due to resin-made or changes with passage of time, predetermined operation can be securely performed without detachment.

Since the key-switch device is configured in the manner described in the third aspect of the present invention, the first lever can be smoothly assembled while sliding it in contact on the top surface of the lever holding plate.

### BRIEF DESCRIPTION OF THE DRAWINGS

FIG. 1 is a sectional view of a key-switch device according to an embodiment of the present invention;

FIG. 2 is a plan view of the key-switch device according to the embodiment of the present invention, in which a key-top is omitted;

FIG. 3 is a partial plan view of the key-switch device according to the embodiment of the present invention viewed from the back-face side of a key-top;

FIG. 4 is a back view of the key-top in the key-switch device according to the embodiment of the present invention;

FIG. 5 is a sectional view of the key-top shown in FIG. 4;

FIG. 6 is a plan view of a lever holding plate in the key-switch device according to the embodiment of the present invention;

FIG. 7 is a drawing of the lever holding plate shown in FIG. 6 and viewed in the arrow direction at the line 7-7;

FIG. 8 is a drawing of the lever holding plate shown in FIG. 6 and viewed in the arrow direction at the line 8-8;

FIG. 9 is a plan view of an outside lever in the key-switch device according to the embodiment of the present invention;

FIG. 10 is a front view of the outside lever shown in FIG. 9;

FIG. 11 is a partially enlarged view of the outside lever shown in FIG. 10;

FIG. 12 is a rear view of the outside lever shown in FIG. 9;

FIG. 13 is a side view of the outside lever shown in FIG. 9;

FIG. 14 is a sectional view of the outside lever shown in FIG. 9 at the line 14-14;

FIG. 15 is a drawing of the outside lever shown in FIG. 9 and viewed in the arrow direction at the line 15-15;

FIG. 16 is a partially enlarged sectional view of the outside lever shown in FIG. 15;

FIG. 17 is a back view of the outside lever shown in FIG. 9;

FIG. 18 is a drawing of the outside lever shown in FIG. 17 and viewed in the arrow direction at the line 18-18;

FIG. 19A is a plan view of an inside lever in the key-switch device according to the embodiment of the present invention;

FIG. 19B is a side view of the inside lever;

FIG. 20A is a plan view of an actuator member in the key-switch device according to the embodiment of the present invention;

FIG. 20B is a sectional view of the actuator member viewed in the arrow direction at the line 20B-20B;

FIG. 21A is a partial plan view for illustrating assembling of a link member in the key-switch device according to the embodiment of the present invention;

FIG. 21B is a rear view of the link member;

FIG. 22 is a partial plan view of the key-switch device according to the embodiment of the present invention, in which the key-top is removed;

FIGS. 23A, 23B, and 23C are schematic representations for illustrating assembling of the link member in the key-switch device according to the embodiment of the present invention: FIG. 23A is a schematic representation for illustrating a state before the link member is assembled into the lever holding plate; FIG. 23B is a schematic representation for illustrating a state that the link member is placed on the lever holding plate; and FIG. 23C is a schematic representation for illustrating a state that the link member is assembled into the lever holding plate;

FIG. 24 is a schematic representation for illustrating an example of assembling operation of the link member into the lever holding plate in the key-switch device according to the embodiment of the present invention;

FIG. 25 is a schematic representation for illustrating assembling of the key-top into the link member in the key-switch device according to the embodiment of the present invention;

FIG. 26 is a sectional view of a conventional key-switch device;

FIG. 27 is an assembly view of the conventional key-switch device;

FIG. 28 is a plan view of one link member for use in the conventional key-switch device; and

FIG. 29 is a plan view of the other link member for use in the conventional key-switch device.

### DESCRIPTION OF THE PREFERRED EMBODIMENTS

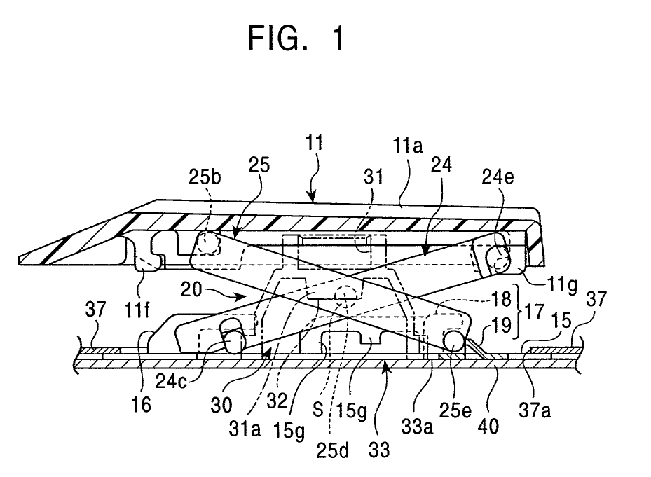

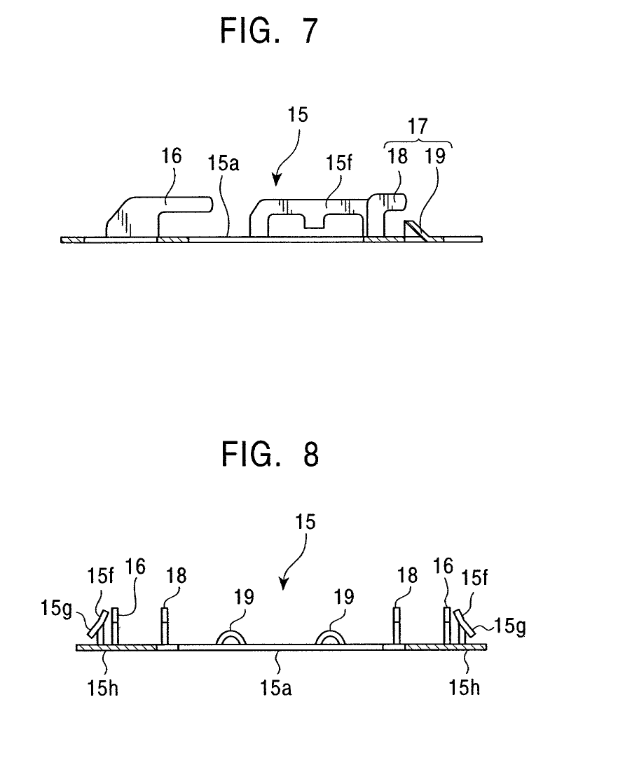

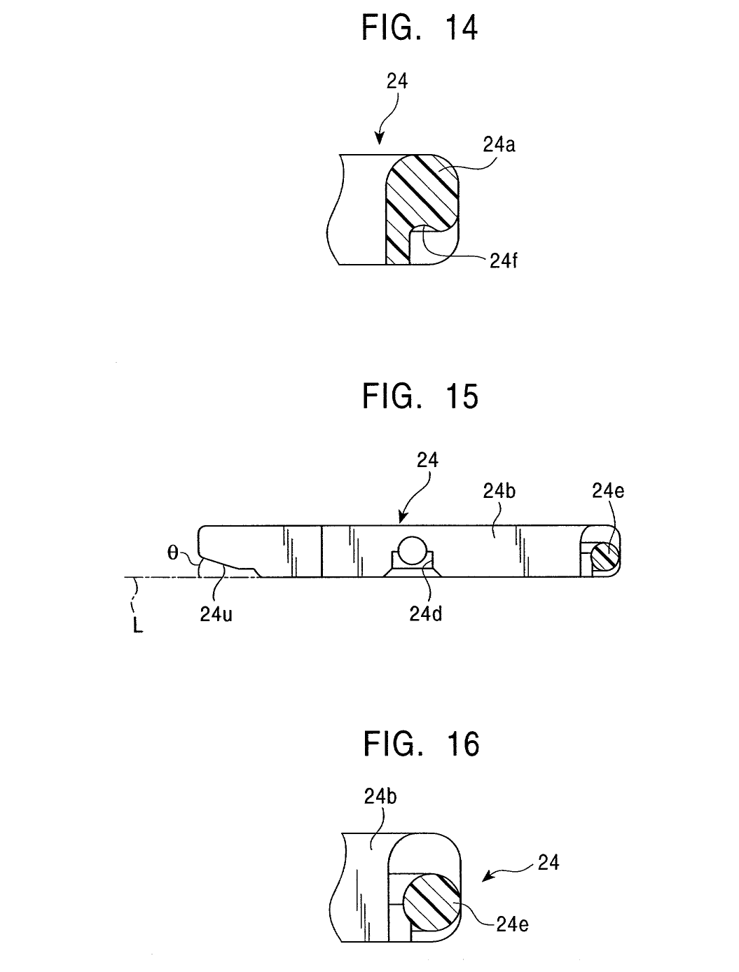

A key-switch device according to an embodiment of the present invention will be described with reference to FIGS. 1 to 25.

The key-switch device, as shown in FIG. 1, principally comprises a key-top 11 made of a resin, a lever-holding plate 15 disposed beneath the key-top 11, a link member 20 for guiding and supporting the key-top 11 between an elevated position of the key-top separated from the lever-holding plate 15 and a lowered position coming closer to the lever-holding plate 15, and a switch member 30 arranged between the link member 20 and the lever-holding plate 15.

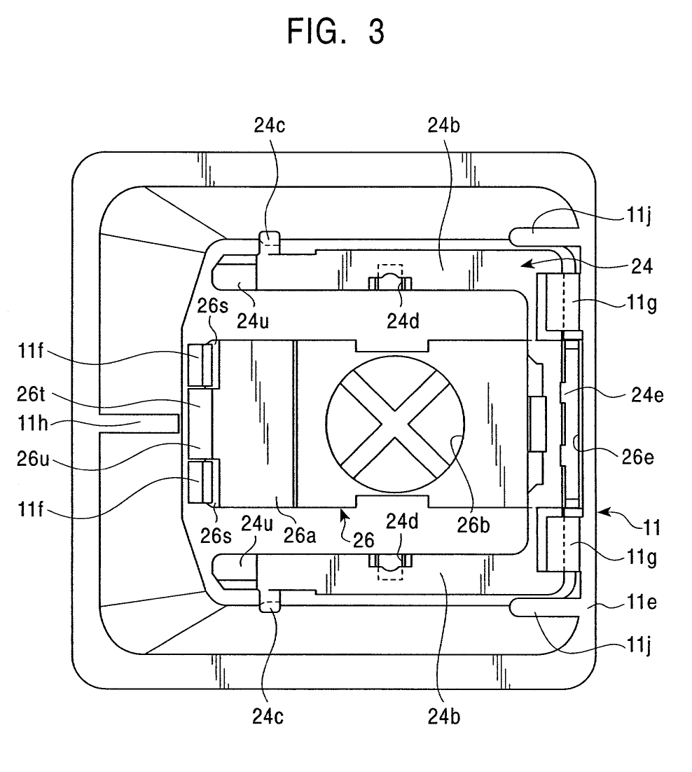

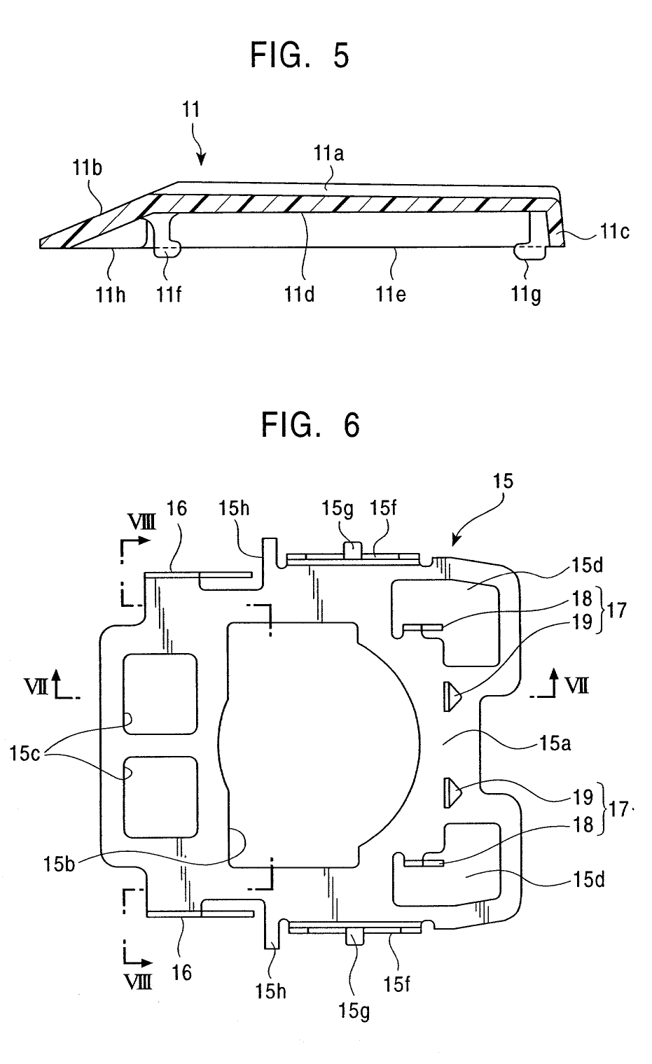

The key-top 11 with a substantially rectangular external-shape, as shown in FIGS. 3 to 5, comprises an operating surface 11a (see FIG. 5) with a character (not shown) such as an alphabet printed on the top surface thereof, an inclined surface 11b slantingly formed in the front (the left side in FIG. 5), a rear face 11c formed substantially at a right angle in the rear, a back surface 11d formed underneath the operating surface 11a substantially in parallel with the operating surface 11a, and an external-peripheral-fringe surface 11e formed on the external-peripheral fringe in the side of the back surface 11d.

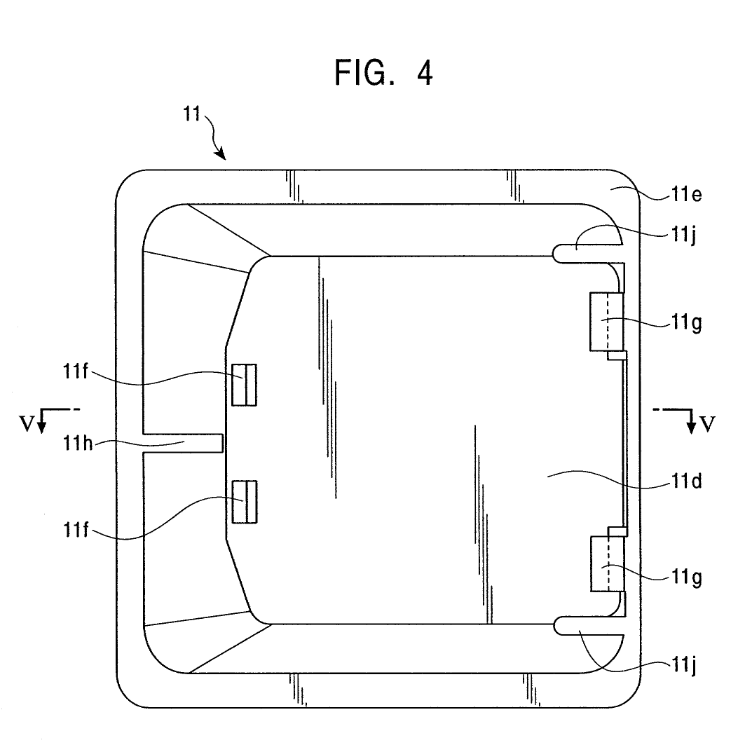

The back and forth sides (both the lateral sides in FIG. 4) of the back surface 11d are provided with a pair of first hook-like retainers 11f arranged to oppose each other and to be spaced by a predetermined distance therebetween and a pair of hook-like second retainers (retainers) 11g arranged to oppose each other and to be spaced by a distance larger than that of the first retainers 11f, both the first and second retainers 11f and 11g being arranged integrally with the back surface 11d so as to protrude downwardly.

The back surface 11d of the key-top 11 is provided with a pair of first ribs 11j formed to protrude from the back surface 11d in the vicinity of the exterior of the second retainers 11g opposing each other and a second rib 11h formed to extend in parallel with the first ribs 11j in the vicinity of the first retainers 11f other than a position between the first retainers 11f, both the first and second ribs 11j and 11h being arranged integrally with the back surface 11d so as to be flush with the external-peripheral-fringe surface 11e.

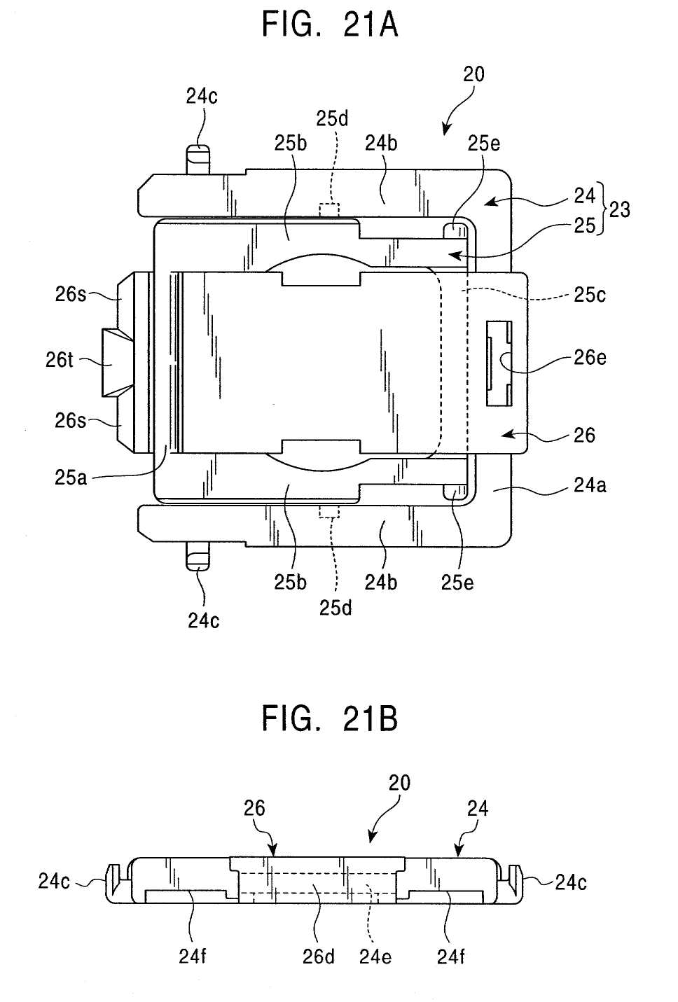

The link member 20, as shown in FIGS. 1, 21A, and 21B, comprises a pair of lever members (a first lever 24 and second lever 25) 23 and one actuator member 26.

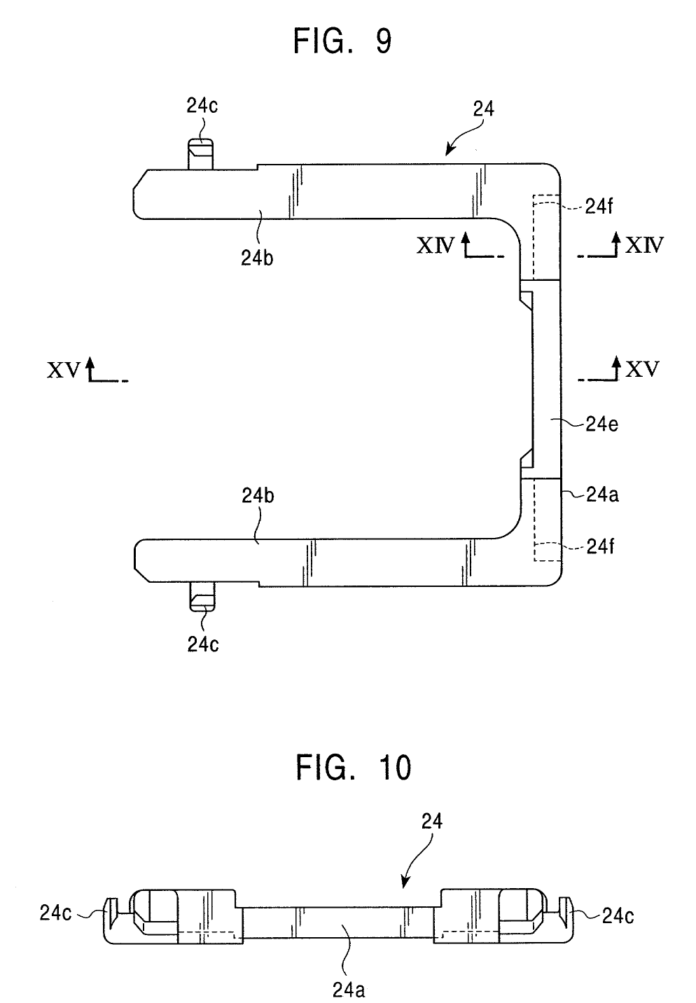

The first lever (outside lever) 24 made of a resin, as shown in FIGS. 9 to 18, comprises a base-end part 24a and a pair of arms 24b integrally arranged to extend from both ends of the base-end part 24a and to oppose each other, the base-end part 24a and the arms 24b being arranged to be a substantially U-shape.

The end (the other end) of each arm 24b is a free end and is provided with a pair of retaining pins (detachment preventing parts) 24c formed to outwardly protrude.

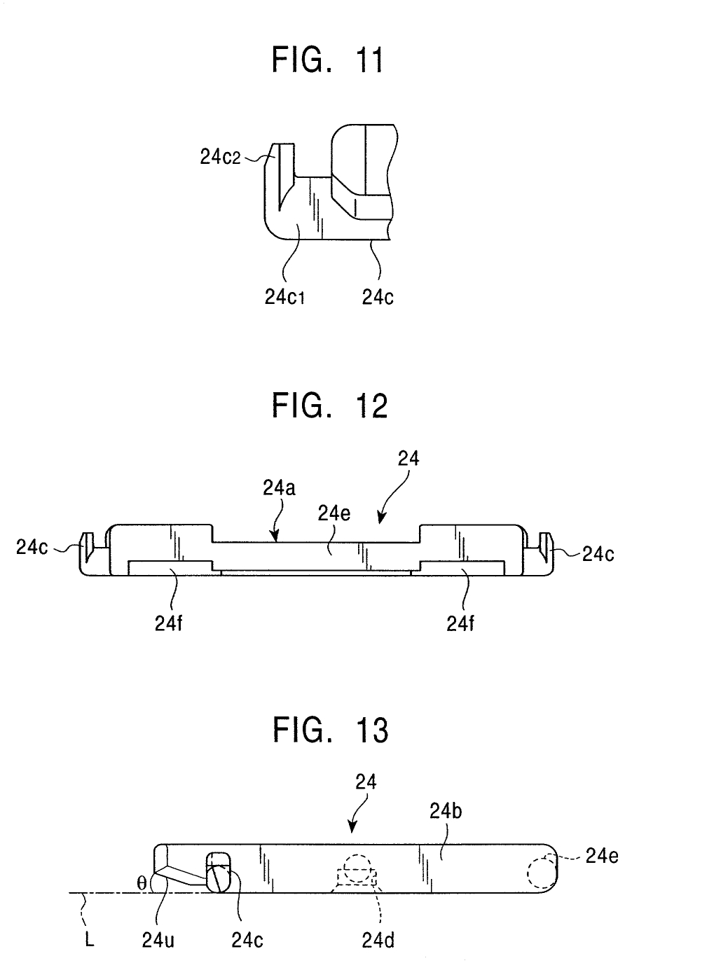

More specifically, the retaining pin 24c comprises a sliding contact part 24c1 formed on the external wall of the arm 24b in the end side to extend in parallel with the longitudinal direction of the base-end part 24a and an end part 24c2 bent upwardly from the end of the sliding contact part 24c1 at a substantially right angle (see FIG. 11).

Also, the end (lower end) of the arm 24b, as shown in FIGS. 13 and 15, is provided with an inclined part 24u formed by slantingly cutting an end face thereof so as to have an acute angle (θ) relative to an extending direction (extension line L) of each arm 24b.

The base-end part 24a, as shown in FIG. 16, is provided with a support-receiving part 24e formed in the central part of the base-end part 24a so as to have a circular cross-section with a small diameter and retainer-receiving parts 24f formed in both-ends sides of the base-end part 24a so as to have a substantially L-shaped cross-section (see FIG. 18).

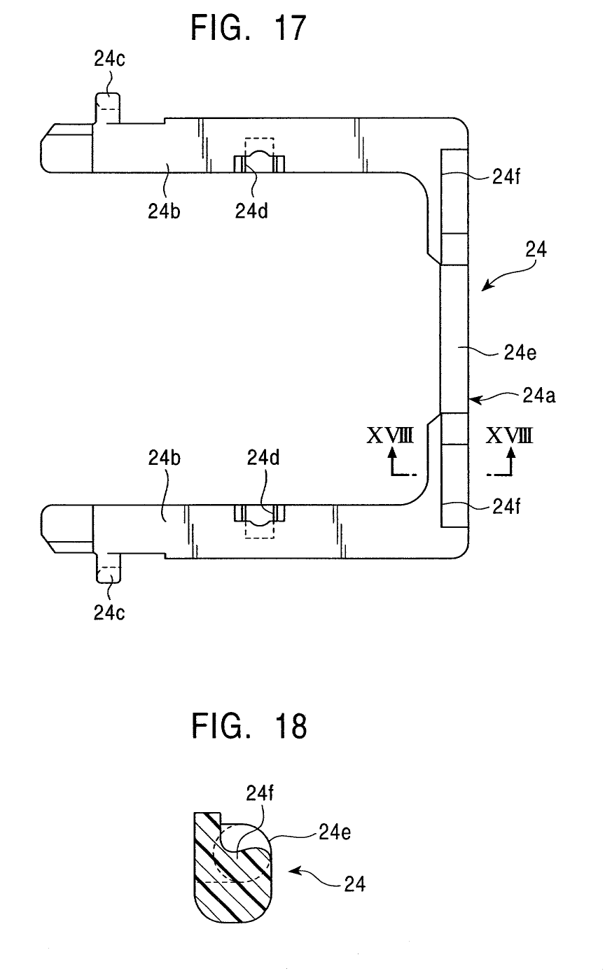

To the retainer-receiving parts 24f, the pair of second retainers 11g of the key-top 11 are tightly fitted in mating, and when the retainer-receiving parts 24f of the first lever 24 oppose the second retainers 11g of the key-top 11, the section of the retaining part thereof is to be two-commas patterned (see FIG. 18). On internal walls of the arms 24b in substantially central parts, as shown in FIG. 17, engaging slots 24d and 24d are formed by cutting-up from the inside so as to oppose each other.

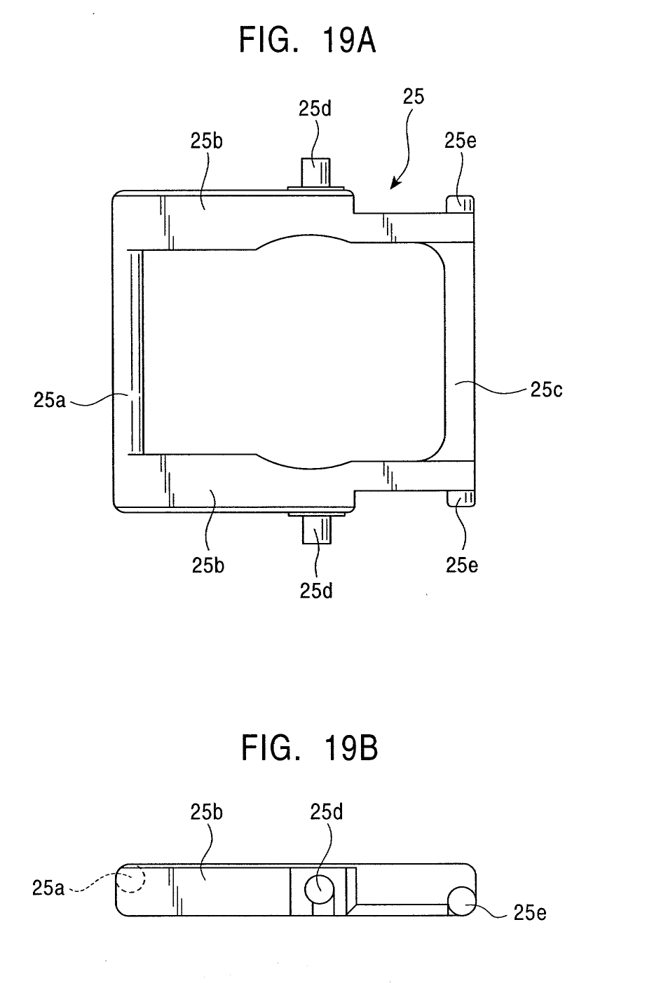

The second lever (inside lever) 25 made of a rectangular resin-frame having an opening in the center, as shown in FIGS. 19A and 19B, comprises a base-end part 25a, a base-shaft part 25c arranged in parallel with the base-end part 25a, and a pair of arms 25b arranged in parallel with each other so as to integrally connect respective both ends of the base-end part 25a and the base-shaft part 25c together.

On the substantially central outside wall of each arm 25b, an engaging shaft 25d is formed to protrude outside.

On the outside wall of each arm 25b in the side of the base-shaft part 25c, a lower-rotational-retaining projection 25e is formed to protrude outside.

The respective engaging shafts 25d are brought into engagement with the engaging slots 24d of the first lever 24 so as to form an intersecting point S (see FIG. 1), so that the first lever 24 and the second lever 25 are rotatable with each other via the intersecting point S. In addition, the base-shaft part 25c is placed as the lower end of the second lever 25.

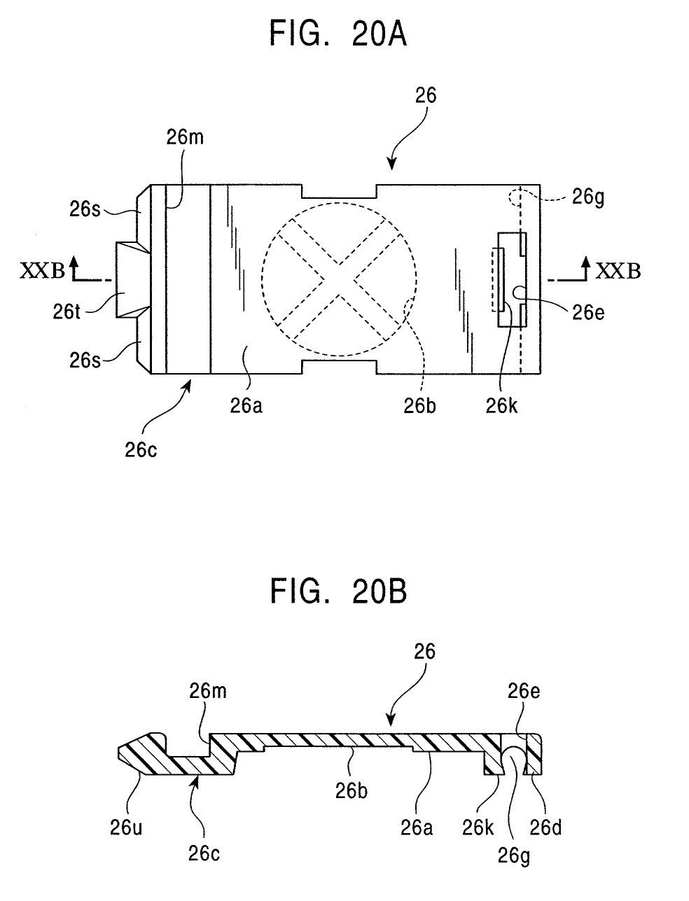

Then, the actuator member 26 made of a resin, as shown in FIGS. 20A and 20B, comprises a base 26a having a substantially rectangular flat-plate shape. The base 26a is provided with a rubber-cap abutting part 26b formed on the central back surface to have a circular shape with a thin thickness.

On the back surface of the base 26a, a substantially rectangular retaining-projection 26d is integrally formed on one end side of the longitudinal direction of the base 26a (in the right of FIG. 20A) so as to protrude from the base 26a. Also, on the central internal side of the retaining projection 26d, a second retaining-projection 26k is integrally formed so as to protrude from the back surface of the base 26a and to oppose the retaining-projection 26d.

The base 26a between the retaining-projection 26d and second retaining-projection 26k is provided with a substantially rectangular retaining-hole 26e formed so as to pass through the base 26a, and a circular slot 26g with a C-shaped cross-section is formed along the retaining-hole 26e on one end side of the actuator member 26.

On the base 26a, an upper slide-receiving part (slide retainer-receiving part) 26c having a substantially U-shaped cross-section is formed on the other end side of the longitudinal direction of the base 26a (in the left of FIG. 20A). The upper slide-receiving part 26c is provided with a groove 26m with an open upper part.

Furthermore, on the central outside end-face of the upper slide-receiving part 26c (on the left end-face of FIG. 20A), a retaining projection 26t is formed to protrude, and on both sides of the retaining projection 26t, retaining-receiving parts 26s are respectively formed.

Also, the lower corner of the retaining projection 26t of the upper slide-receiving part 26c is formed to be an inclined-face part 26u by diagonally cutting.

Next, the lever holding plate 15, as shown in FIGS. 6 to 8, comprises a base 15a formed of a substantially rectangular metallic flat plate.

As shown in FIG. 6, the base 15a of the lever holding plate 15 is provided with a through-opening 15b formed in the central part.

On one end side of the base 15a (in the left of the drawing), a pair of first rectangular openings 15c are formed close to the through-opening 15b, and on the other end side of the base 15a (in the right of the drawing), a pair of second substantially rectangular openings 15d are formed to have a predetermined space therebetween.

The base 15a is further provided with a retainer unit 17 comprising a pair of detachment-preventing retainers (projections) 19 disposed between the pair of second rectangular openings 15d and a pair of lower rotational retainers 18 formed to respectively face the internal sides of the second rectangular openings 15d.

Specifically, the pair of lower rotational retainers 18 are formed by cutting-up the internal edges of the second rectangular openings 15d at a substantially right angle so as to have a substantially L-shape, and the pair of detachment-preventing retainers (projections) 19 are formed by projecting so as to protrude partly from the top surface of the base 15a to form fractured planes erected at a substantially right angle on the side of the through-opening 15b.

As shown in FIG. 6, the lever holding plate 15 is provided with a pair of lower-slide retainers 16 formed at corners on the sides of the base 15a (vertical sides of FIG. 6) by cutting-up from the base 15a at a substantially right angle so as to have an L-shape.

At side ends of the base 15a (ends on vertical sides of the drawing), cut-up parts 15f are formed by cutting-up from the base 15a at a substantially right angle and arranged to be adjacent to the right in the drawing of the lower-slide retainers 16.

The central part of each cut-up part 15f is a cut-slot, in which a tongue piece 15g extends downwardly and also slightly protrudes outwardly.

The base 15a is further provided with detachment-preventing-protruded pieces 15h integrally formed at side ends of the base 15a (ends on vertical sides in FIG. 6) and arranged to be adjacent to the cut-up parts 15f.

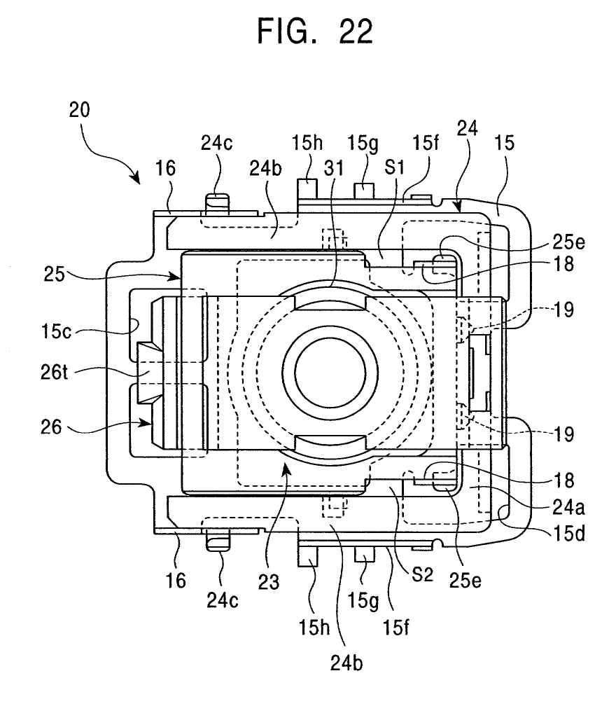

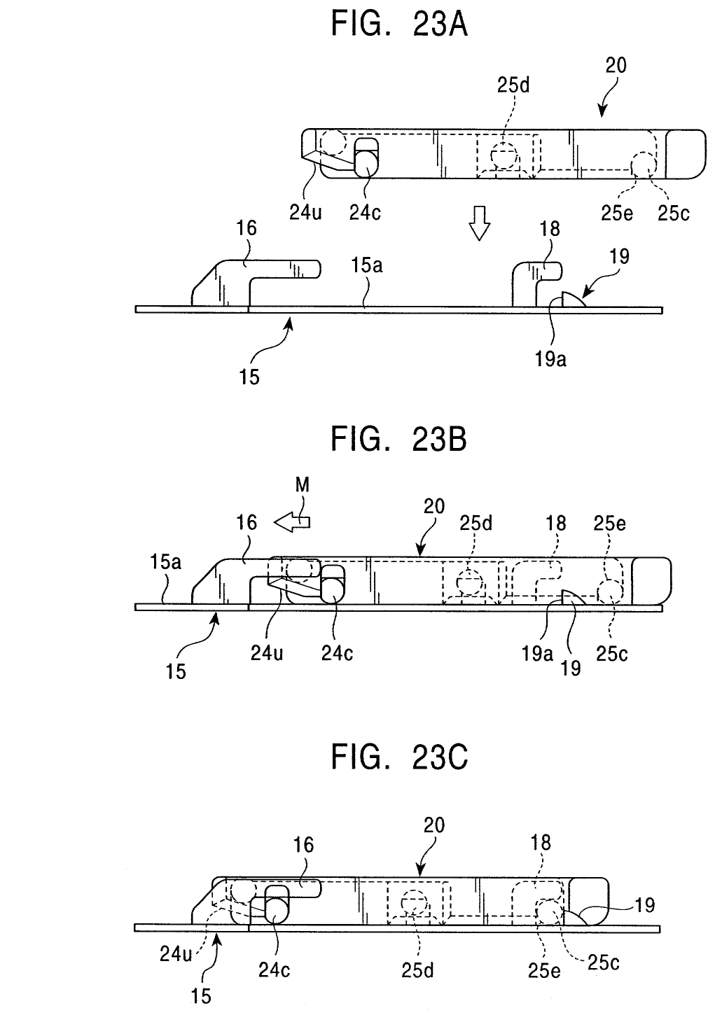

Then, the switch member 30, as shown in FIGS. 1 and 22, is a so-called membrane switch having an elastic rubber cap 31 arranged in the upper part.

The switch member 30 comprises an insulating film sheet 33 and a pair of fixed electrodes (not shown), which are arranged on the film sheet 33 as part of plural switching elements.

The rubber cap 31 is provided with a pressing projection 31a, which is formed inside a dome-like ceiling part of the rubber cap 31 so as to protrude downwardly, and a movable electrode 32, which is made of a conductive film and is formed by printing or the like at the end of the pressing projection 31a so as to abut the pair of fixed electrodes for switching.

Then, the lower end of the rubber cap 31 is bonded on the film sheet 33 with an adhesive, etc., so that the movable electrode 32 of the pressing projection 31a opposes the fixed electrode (not shown).

A rectangular metallic holding plate 37 having plural openings 37a is put on top of the lever holding plate 15, and the pair of lower-slide retainers 16, the pair of lower rotational retainers 18, the detachment-preventing retainers (projections) 19, and the link member 20, which are formed on the lever holding plate 15, protrude upwardly from the openings 37a.

Under the film sheet 33, a metallic plate 40 is also laid.

Next, an assembling method of the key-switch device configured in such a manner will be described below with reference to FIGS. 21A and 21B to 25.

First, as shown in FIGS. 21A and 21B, the first lever (outside lever) 24 is put on the second lever (inside lever) 25 from the upper part so that each engaging slot 24d of the first lever 24 is brought into engagement with each engaging shaft 25d of the second lever 25 so as to assemble the lever members 23 which are connected together so as to be rotatable about an intersecting point S.

Continuously, the actuator member 26 is prepared; the side of the retaining projection 26t of the actuator member 26 is inserted into the central opening part of the second lever 25 among the first and second levers 24 and 25 forming the lever members 23, while in this state, the base-end 25a of the second lever is abutted to the inside the upper slide-receiving part 26c. Then, the retaining-projection 26d is downward moved to the support-receiving part 24e of the first lever 24 so that the slot 26g of the retaining-projection 26d is snapped and fitted into the support-receiving part 24e. In such a manner, the link member 20 is completed.

Next, as shown in FIG. 23A, the lever holding plate 15 is prepared; the link member 20 is downward inserted on the top surface of the lever holding plate 15. The link member 20 is placed on the top surface of the lever holding plate 15 in a state that the first and second levers 24 and 25 of the link member 20 overlap horizontally.

Then, as shown in FIG. 23B, the link member 20 is moved in the M direction of the drawing while sliding the link member 20 in contact with the top surface of the base 15a of the lever holding member 15 in the state that the first and second levers 24 and 25 of the link member 20 overlap horizontally. At that, each retaining pin 24c of the first lever 24 is slidably brought into engagement with the lower-slide retainer 16.

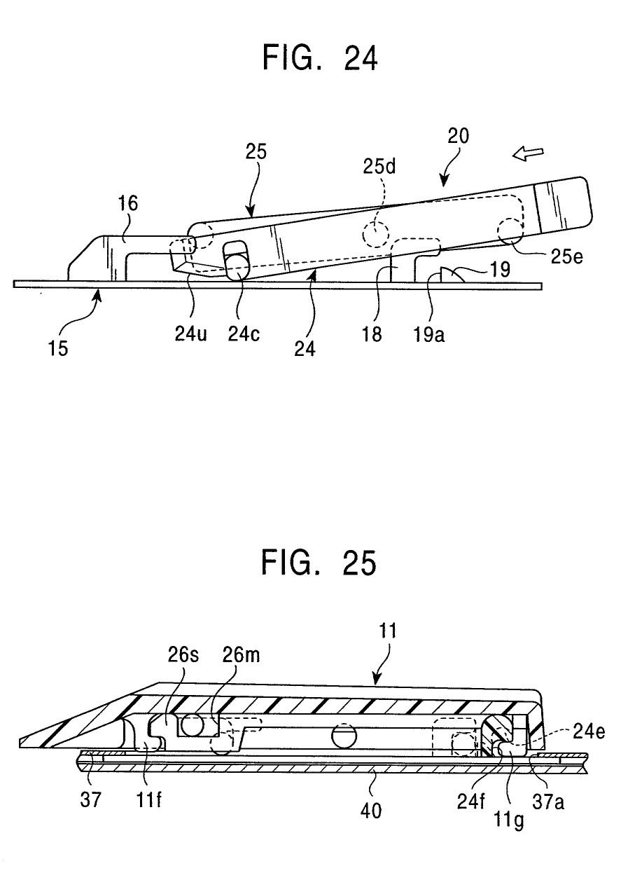

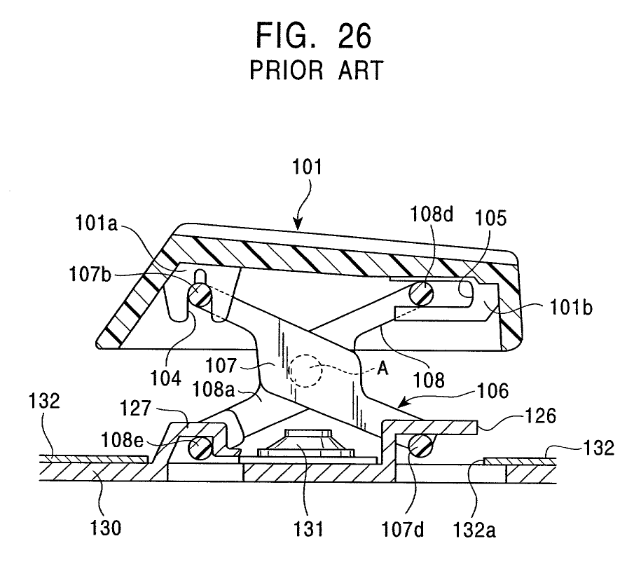

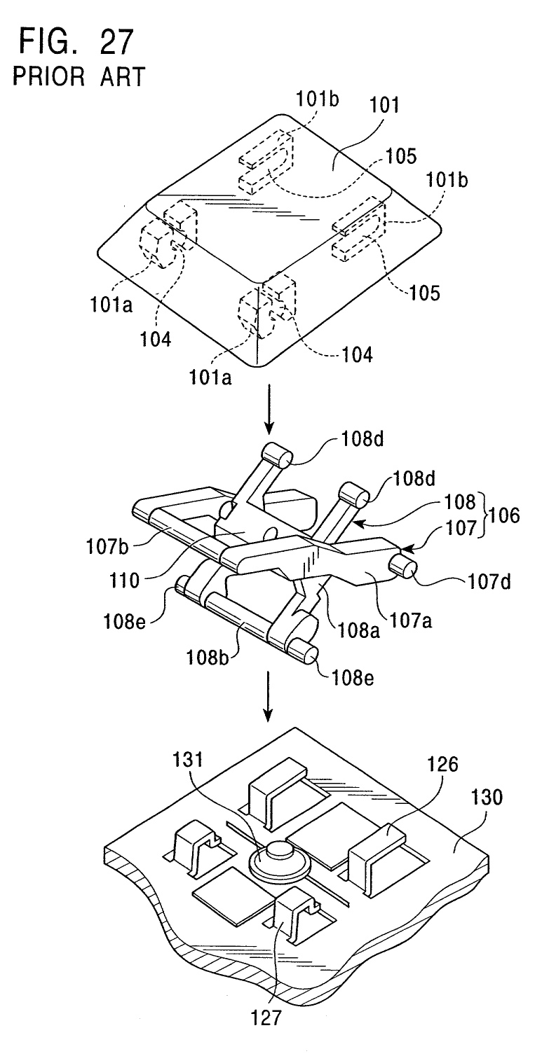

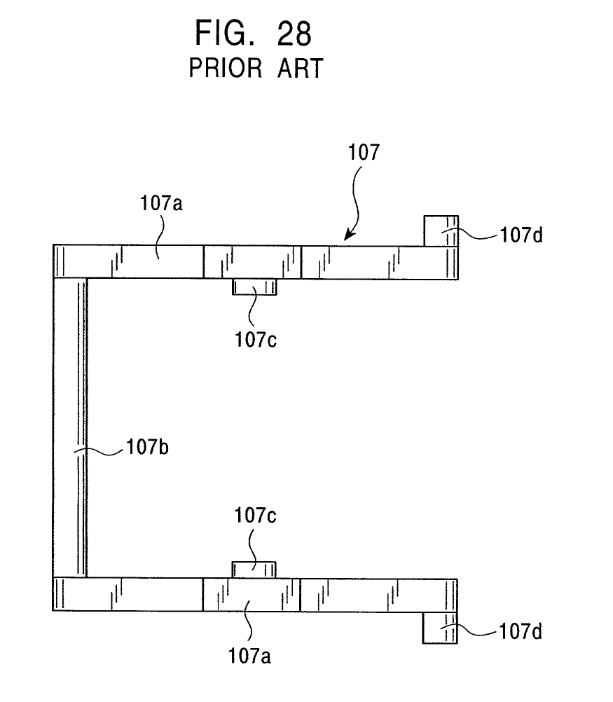

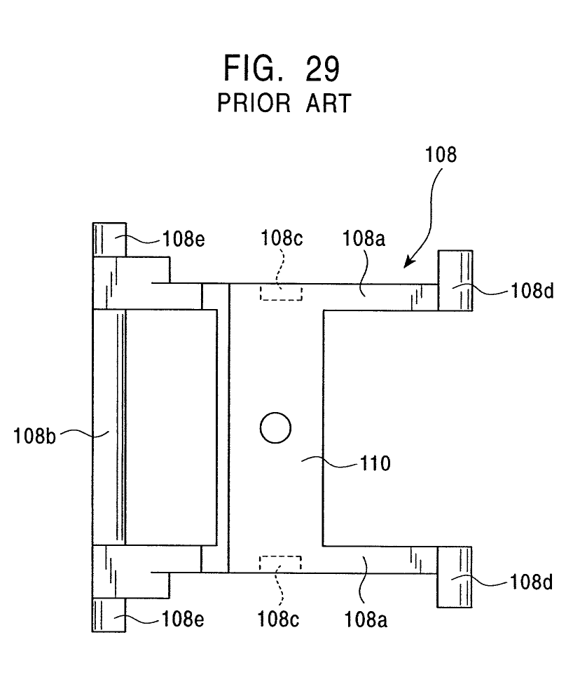

In addition, even when the link member 20 is oblique relative to the top surface of the base 15a of the lever holding member 15, as shown in FIG. 24, or even when the retaining pin 24c is directly inserted into the lower-slide retainer 16 obliquely from the rear (upper right in FIG. 23A), the link member 20 can be smoothly inserted without any resistance by inserting it along the inclined part 24u of the first lever 24.

Since the upper slide-receiving part 26c, which is the free end of the actuator member 26, is rotatably journaled by the support-receiving part 24e of the first lever 24 via the circular slot 26g, the inclined-face part 26u slides on the top surface of the base 15a of the lever holding plate 15 during the assembling. At this time, the link member 20 is smoothly inserted due to oblique chamfering.

The base-shaft part 25c of the second lever 25 gets over the pair of detachment-preventing retainers 19 of the lever holding plate 15 while sliding in contact with them so as to be positioned in the clamped state between the lower rotational retainers 18 and the fractured planes of the detachment-preventing retainers 19, while the lower-rotational-retaining projections 25e are brought into the lower rotational retainers 18.

In such a manner, the lower ends of the first and second levers of the link member 20 are attached on the lever holding plate 15.

Next, the lever holding plate 15 having the link member 20 attached thereto is upward inserted toward the openings 37a of the holding plate 37 and is brought into engagement therewith by snapping-in the cut-up parts 15f of the lever holding member 15.

Continuously, the film sheet 33 having the rubber cap 31 bonded to the lower end thereof with an adhesive in advance is arranged under the holding plate 37. Then, the film sheet 33 is put on the holding plate 37 while the rubber-cap abutting part 26b of the actuator member 26 abuts the top of the rubber cap 31, and the metallic plate 40 is further put under the film sheet 33 (see FIG. 22).

Next, the key-top 11 is prepared: the key-top 11 is downward put on the link member 20, which is exposed from the openings 37a of the holding plate 37.

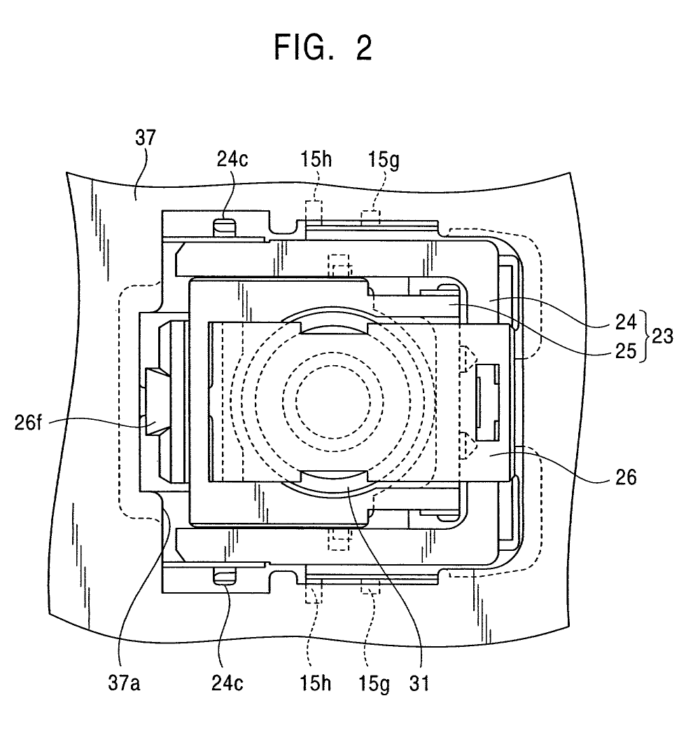

At this time, to the link member 20, which is at the elevated position due to the elastic force of the rubber cap 31 as shown in FIG. 1, the key-top 11 is downward pressed using the pair of first ribs 11j and the second rib 11h as guides during inserting the key-top 11. Then, as shown in FIG. 3, the retaining projection 26t of the actuator member 26 is fitted between the first retainers 11f, so that the first retainers 11f of the key-top 11 are snapped in the retaining-receiving parts 26s, while the retaining-projection 26d of the actuator member 26 is arranged between the second retainers 11g, so that the second retainers 11g of the key-top 11 are snapped in the retainer-receiving parts 24f (see FIGS. 2 and 3).

Then, the rubber cap 31 recovers due to the elastic force thereof so that the link member 20 is elevated. According to the elevation, the sliding contact part 24c1 of the retaining pin 24c of the first lever 24 securely slides within the lower-slide retainer 16 while being guided by the end part 24c2, thereby completing the key-switch device shown in FIG. 1.

The embodiment according to the present invention has been described; however, the present invention is not limited the embodiment described above, and modifications may be made within the spirit and scope of the invention.

The key-switch device according to the embodiment configured and assembled as described above has the advantages as follows:

1) The actuator member 26 has the slide-receiving part 26c formed therein having the groove 26m with an open upper part, and the base-end part 25a of the second lever 25 is slidably retained to the slide-receiving part 26c, so that the key-top 11 can be readily installed while maintaining a predetermined intersecting angle between the first and second levers 24 and 25 due to the actuator member 26.

2) The base-end part 24a of the first lever 24 has the support-receiving part 24e at the center for retaining one end of the actuator member 26 while the retainer-receiving parts 24f for retaining the second retainers 11g of the key-top 11 are formed on both sides of the support-receiving part 24e, so that the second retainers 11g and the retainer-receiving parts 24f are opposed and retained to each other. This portion is formed to have a patterned section shaped like two-commas, so that even when an external force is accidentally applied to the key-top 11, the key-top 11 can be securely held not to simply come off the link member 20.

3) The retainer of the key-top 11 comprises a pair of first retainers 11f and a pair of second retainers 11g, which are formed on the back surface 11d so as to protrude therefrom, and the back surface 11d of the key-top 11 is provided with a pair of first ribs 11j formed to protrude from the back surface 11d in the vicinity of the exterior of the second retainers 11g opposing each other and a second rib 11h formed to extend in parallel with the first ribs 11j in the vicinity of the first retainers 11f other than any position between the first retainers 11f, and then, the key-top 11 is mounted by respectively guiding the pair of arms 24b of the first lever 24 and the other end of the actuator member 26 with the first ribs 11j and the second rib 11h. Thereby, the key-top 11 can be simply and securely mounted by using the first ribs 11j and the second rib 11h as guides without mounting by guessing roughly as in a conventional device.

4) The base-end part 24a of the first lever 24 is journaled on bearings by the one end of the actuator member 26, and the lower corner of the other end of the actuator member 26 is obliquely cut, so that the actuator member 26 can be smoothly assembled while sliding it in contact with the top surface of the base 15a of the lever holding plate 15.

5) The retaining section of the lever-holding plate 15 comprises a lower-slide retainer 16 for slidably retaining the lower end of the first lever 24 and a retainer unit 17 for rotatably journaling the lower end of the second lever 25 on bearings, and the lower end of the first lever 24 is provided with a retaining pin 24c, which is a detachment preventing part formed for preventing the lower end of the first lever 24, so that when the key-top 11 is pressed to operate, even when the sliding first lever 24 deflects due to resin-made or changes with passage of time, predetermined operation can be securely performed without detachment.

6) At the lower end of the first lever 24, the end face sliding on the top surface of the base 15a of the lever-holding plate 15 is obliquely cut so as to have an acute angle relative to the extending direction of each of the arms 24b, so that the lower end of the first lever 24 can be smoothly assembled while sliding the first lever 24 in contact with the top surface of the base 15a of the lever holding plate 15.

What is claimed is:

1. A key-switch device comprising:
a key-top having retainers formed on the back surface of the key-top;
first and second levers disposed under the key-top, each lever including a base-end part and a pair of arms opposing each other and extending from both ends of the base-end part, the first and second levers being connected together rotatably about the substantial center of the pair of arms as an intersecting point;
a lever-holding plate, which can retain each lower end of the first and second levers; and
an actuator member attached to and spanned between both the base-end parts of the first and second levers,
wherein the actuator member has a concave slide-retainer-receiving part with the open top, and
wherein the base-end part of the second lever is slidably retained in the slide-retainer-receiving part.

2. A device according to claim 1, wherein the base-end part of the first lever comprises a support-receiving part formed in the center of the base-end part for retaining one end of the actuator member, both ends of the support-receiving part being provided with retainer-receiving parts formed for retaining the retainers of the key-top, and
wherein the retainers of the key-top and the retainer-receiving parts of the first lever are opposed in order to be retained together to have a section shaped like two-commas.

3. A device according to claim 1, wherein the retainers of the key-top are classified into a pair of first retainers and a pair of second retainers, the first and second pairs of retainers being formed on the back surface of the key-top so as to protrude therefrom,
wherein the back surface of the key-top is provided with a pair of first ribs formed to protrude from the back surface in the vicinity of the exterior of the second retainers, which oppose each other, and a second rib formed to extend in parallel with the first ribs in the vicinity of the first retainers other than any position between the first retainers, and
wherein the key-top is inserted into and mounted on the first lever and the actuator member by respectively guiding the pair of arms of the first lever and the other end of the actuator member with the first ribs and the second rib.

4. A device according to claim 3, wherein the base-end part of the first lever is rotatably journaled on bearings by one end of the actuator member, and the lower corner of the other end of the actuator member is obliquely cut.

5. A key-switch device comprising:
first and second levers rotatably connected to each other about an intersecting point;
a key-top supported by the first and second levers so as to be movable up and down;
a switch member being switchably operable in accordance with the up-and-down movement of the key-top; and
a lever-holding plate having retainers for respectively retaining lower ends of the first and second levers,
wherein the retainers of the lever-holding plate are classified into a lower-slide retainer for slidably retaining the lower end of the first lever and a retainer unit for rotatably journaling the lower end of the second lever on bearings, and
wherein the lower end of the first lever is provided with a detachment-preventing part formed for preventing the lower end of the first lever from coming off the lower-slide retainer.

6. A device according to claim 5, wherein the detachment-preventing part is an L-shaped retainer pin formed at the lower end of the first lever so as to protrude, and it is retained in the lower-slide retainer.

7. A key-switch device comprising:
first and second levers rotatably connected to each other about an intersecting point;
a key-top supported by the first and second levers so as to be movable up and down;
a switch member being switchably operable in accordance with the up-and-down movement of the key-top; and
a lever-holding plate having retainers for respectively retaining lower ends of the first and second levers,
wherein the respective first and second levers are provided with a base-end part and a pair of arms formed so as to extend from both ends of the base-end part and to oppose each other, the base-end part and the pair of arms being formed for guiding the up-and-down movement of the key-top,
wherein the retainers of the lever-holding plate are classified into a lower-slide retainer for slidably retaining the lower end of the first lever and a retainer for rotatably journaling the lower end of the second lever on bearings, and
wherein an end face of the first lever at the lower end, the end face sliding on the top surface of the lever-holding plate, is obliquely cut so as to have an acute angle relative to the extending direction of each arm.

8. A key-switch device comprising:
a key-top having a plurality of retainers formed on the back surface of the key-top;
first and second levers disposed under the key-top, each lever including a base-end part and a pair of arms opposing each other and extending from both ends of the base-end part, the pairs of the arms being arranged movably with each other;
a lever-holding plate, which can retain each of lower ends of the first and second levers;
a connection member attached to and spanned between both of the base-end parts of the first and second levers; and
a sheet switch arranged on the bottom surface of the lever-holding plate,
wherein both ends of the connection member are provided with engaging parts formed for retaining to the retainers of the key-top, and the lever-holding plate is made of a metallic flat plate having substantially the same area as that of the key-top.

9. A key-switch device comprising:
first and second levers connected to each other rotatably about an intersecting point;
a key-top supported by the first and second levers so as to be movable up and down;
a switch member being switchably operable in accordance with the up-and-down movement of the key-top; and
a lever-holding plate for respectively retaining lower ends of the first and second levers,
wherein the lever-holding plate is provided with a lower-slide retainer for slidably retaining the lower end of the first lever and a retainer unit for rotatably journaling the lower end of the second lever on bearings.

10. A device according to claim 9, wherein part of the retaining part is open and the retaining part comprises a lower-rotational retainer for positioning the lower end of the second lever and a detachment-preventing retainer for preventing the lower end of the second lever from coming-off.

11. A device according to claim 10, wherein the detachment-preventing retainer is a projection protruding from the lever-holding plate.

12. A device according to claim 10, wherein the second lever comprises a pair of arms arranged in parallel with each other, a connection part for connecting one end of one arm to that of the other arm of the pair of arms, and a pair of lower-rotational-retaining projections formed to extend from each of the arms, in which the connection part is formed, and
wherein the respective lower-rotational-retaining projections are retained in the lower-rotational retainer.

13. A device according to claim 11, wherein the projection is provided with a fractured plane formed by projecting part of the lever-holding plate, and the connection part abuts the fractured plane.

14. A device according to claim 12, wherein a plurality of the projections are formed along the connection part in the vicinity of the lower-rotational retainer, and the connection part is clamped with the lower-rotational retainer and the projections for preventing detachment.
